(19) United States
(12) Patent Application Publication
(10) Pub. No.: US 2024/0244389 A1
(43) Pub. Date: Jul. 18, 2024

(54) DEEP LEARNING SOLUTION FOR VIRTUAL ROTATION OF BINAURAL AUDIO SIGNALS

(71) Applicant: Intel Corporation, Santa Clara, CA (US)

(72) Inventors: Hector Cordourier Maruri, Guadalajara (MX); Jesus Ferrer Romero, Guadalajara (MX); Willem Beltman, West Linn, OR (US); Georg Stemmer, Munich (DE)

(73) Assignee: Intel Corporation, Santa Clara, CA (US)

(21) Appl. No.: 18/434,163

(22) Filed: Feb. 6, 2024

(51) Int. Cl. H04S 7/00; G10L 19/008; G10L 19/02; G10L 25/30; H04S 3/00

(52) U.S. Cl. CPC H04S 7/304; G10L 19/008; G10L 19/02; G10L 25/30; H04S 3/008; H04S 2400/01; H04S 2400/11; H04S 2420/01

(57) ABSTRACT

Techniques are provided herein for providing binaural sound signals that are virtually rotated to match head rotation, such that audio output to headphones is perceived to maintain its location relative to user when a user turns their head. In particular, techniques are presented to extract spherical location information already embedded in binaural signals to generate binaural sound signals that change to match head rotation. A deep-learning based audio regression method can use a 2-channel binaural audio signal and a rotation angle as input, and generate a new binaural audio output signal with the rotated environment corresponding to the rotation angle. The deep-learning based audio regression method can be implemented as a neural network, and can include deep learning operations, such as convolution, pooling, elementwise operation, linear operation, and nonlinear operation. A deep learning operation may be performed on internal parameters of the DNNs and one or more activations.

### TECHNICAL FIELD

This disclosure relates generally to binaural audio signals, and in particular to virtual rotation of binaural audio signals.

### BACKGROUND

Binaural sound is audio that is heard by both ears of a listener. In a natural environment, soundwaves from a direction other than central to the listener's head arrive at each ear of a listener at slightly different times and at slightly different volumes. Using the difference in arrival time of the soundwaves and the difference in volume of the soundwaves, a listener's brain can calculate the origin of the sound. The perception of a sound originating from a selected place with respect to a listener's head can be replicated by using binaural recordings and creating a binaural sound, in which the output to each speaker of a pair of stereo headphones (or earphones) is slightly different. When binaural sound is played through headphones, the listener can hear the binaural sound as three-dimensional (3D). However, binaural recordings used for generating binaural sound are recorded and/or generated with a fixed head orientation. A fixed head orientation for binaural sounds results in a phenomenon such that when the listener rotates their head, the binaural sound rotates along with the head and does not automatically change with the head rotation.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an example of the sound location process using binaural sound perception.

FIG. 2 is a block diagram illustrating a system for generating binaural sound with a selected perceived location source angle using HRTFs.

FIG. 3A illustrates four fixed sound sources around a person's head, in accordance with various embodiments.

FIG. 3B illustrates rotation of the four fixed sound sources around a person's head, in accordance with various embodiments.

FIG. 4 is a diagram of an example virtual rotation system, in accordance with various embodiments.

FIG. 5 is a block diagram of a deep neural network (DNN) module that can be used for a virtual rotation system, in accordance with various embodiments.

FIG. 6 is a block diagram illustrating an example of a neural network architecture 600 that can perform virtual rotation of input sound locations, in accordance with various embodiments.

FIG. 7 is a flow chart illustrating an example method for virtual rotation, in accordance with various embodiments.

FIG. 8 is a block diagram of an example computing device, in accordance with various embodiments.

### DETAILED DESCRIPTION

### Overview

Listeners can generally determine where a sound in the environment originates from because sounds arrive at a listener's ears differently depending on where the sound is located with respect to the head. For example, a sound coming directly from the right side of a person's head will reach the right ear clear and crisp while the left ear will receive a version of the sound that is somewhat withered out by the presence of the head and the body in the acoustic path of the sound. The difference in the sound at each ear is used by the human brain to estimate the sound location. Note, however, that a person does not notice any delay or difference between the sounds at each ear even for very short and impulsive sounds (like clapping or a gunshot); the process is quick and organic.

Binaural audio can be recorded using specific capture methods which try to emulate the way audio is heard by an actual human head. The capture methods can include the use of a special mannequin head and the use binaural head-worn microphones placed in a person's ears for the duration of the recording. In some examples, instead of recording binaural audio directly, binaural audio can be generated with special digital filters based on a Head Related Transfer Function (HRTF). A HRTF filter is based on a selected direction the sound source is to be perceived as originating from, with different filter parameters for each selected direction.

The perception of a sound originating from a selected place with respect to a listener's head can be replicated by using binaural recordings and creating a binaural sound in which the output to each speaker of a pair of headphones is slightly different. Alternatively, the perception of a sound originating from a selected place with respect to a listener's head can be replicated by continuously filtering audio recordings using an HRTF filter to generate binaural audio that creates the selected sound direction perception. When binaural sound is played through headphones, the listener can hear the binaural sound as three-dimensional (3D).

In general, binaural recordings used for generating binaural sound are generated with a fixed head orientation, such that when the listener rotates their head, the binaural sound rotates along with the head and does not automatically change with the head rotation. However, head rotation and the associated change in sound field is an important listening and immersion characteristic.

To implement a change in binaural sound that corresponds with head rotation, binaural audio recordings are generally re-obtained with different head positions, or recordings are made with sophisticated and expensive directional microphone arrays. However, these expensive and time-consuming strategies may not be available for sounds that cannot be re-recorded. Another method that can be used to implement a change in binaural sound that corresponds with head rotations is to filter the audio sources with Head Related Transfer Functions (HRTF) that are designed to emulate the binaural experience. However, using HRTFs implies filtering the audio signals and adding multiple audio channels to generate a corresponding HRTF for each source location. Additionally, HRTFs require multiple microphone capture arrays and a known source location for each signal. Thus, a simple binaural signal cannot be used to generate binaural signal rotation using HRTFs.

Systems and methods are presented herein to provide binaural sound signals that change to match head rotation. In particular, techniques are presented to extract spherical location information already embedded in binaural signals to generate the binaural sound signals that change to match head rotation. A deep-learning based audio regression method is discussed herein, which can use a 2-channel binaural audio signal and a selected rotation angle as input, and generate a new binaural audio output signal with the rotated environment corresponding to the selected rotation angle.

According to various implementations, a virtual audio rotation module can include a deep-learning based audio regression method, which can be implemented as a neural network, such as a deep neural network (DNN). As described herein, a DNN layer may include one or more deep learning operations, such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (generated during feature extraction) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor that includes one or more output activations (also referred to as “output elements”).

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Binaural Sound Location

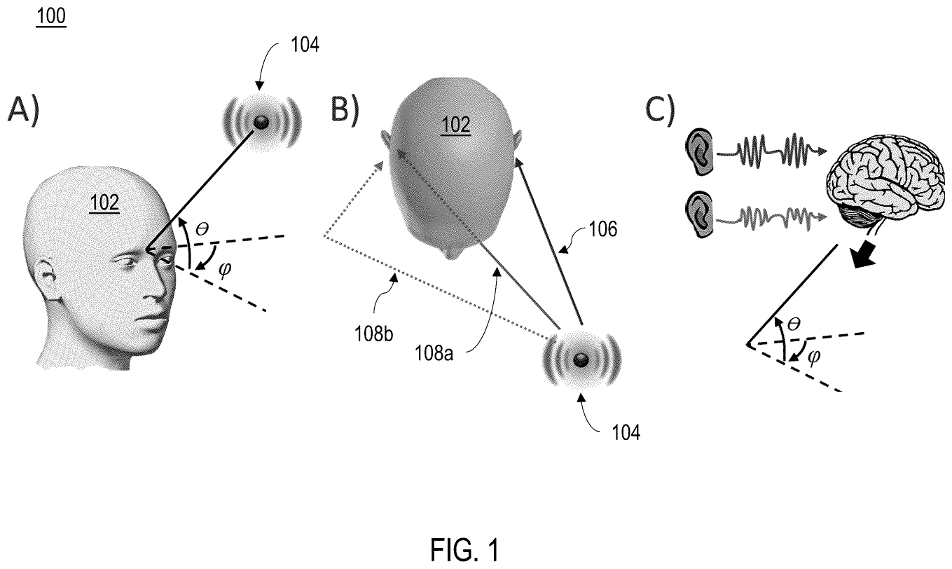

FIG. 1 is a block diagram of an example of the sound location process using binaural sound perception. In particular, as shown in the leftmost panel, a sound originates at a selected location (φ,θ) 104 around the head 102, where is the angle from the center axis on the horizontal plane, and θ is the angle from the center axis in the vertical plane, where the center axis is straight ahead of the face, directly in front of the head. As shown in the center panel, the sound from the location 104 reaches each ear with a different acoustic path. In particular, the sound reaches the left ear with a direct path 106, and the sound reaches the right ear with one or more indirect paths 108a, 108b. The acoustic paths vary depending on the head size, head shape, the pinna, and the environment. The right panel illustrates that the brain uses the difference between the sound received at each ear to estimate the sound location (φ,θ) 104.

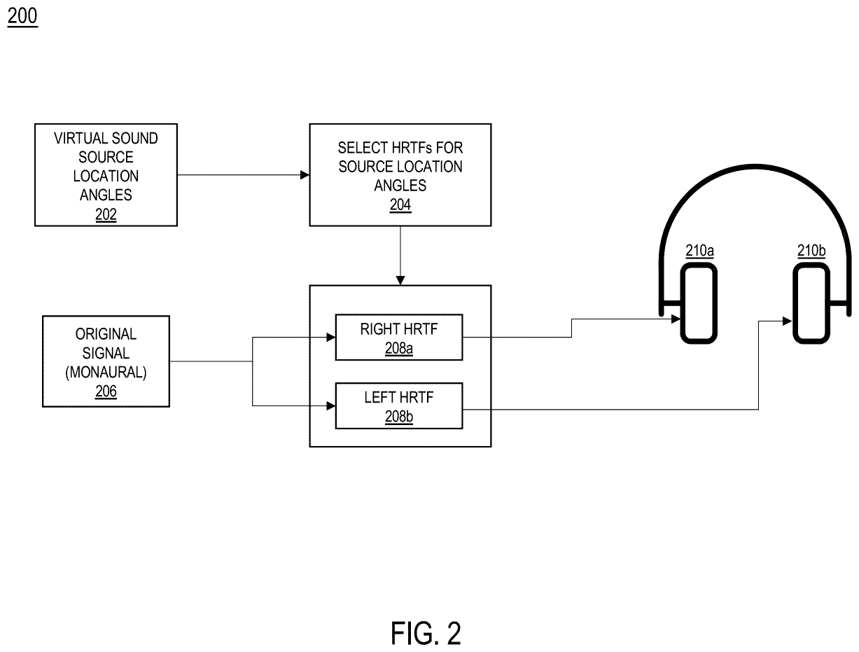

Using the diagram of FIG. 1, binaural sound with a selected perceived location source angle can be generated by selecting digital filters known as HRTFs to filter a monaural sound using selected sound source location angles, and sending the output signals to a pair of stereo headphones. FIG. 2 is a block diagram illustrating a system for generating binaural sound with a selected perceived location source angle using HRTFs. Virtual sound source location angles 202 indicate the desired perceived location of the sound source. At block 204, a HRTF for each ear is selected based on the virtual sound source location angles 202. The original monaural signal 206 is input to a processing block along with the selected HRTFs from block 204. The original monaural signal 206 is processed with the right side HRTF 208a to generate a right ear signal to be played at the right headphone speaker 210a, and the original monaural signal 206 is processed with the left side HRTF 208b to generate a left ear signal to be played at the left headphone speaker 210b. When a listener listens to the signal in the right headphone speaker 210a and the left headphone speaker 201b simultaneously, the listener will perceive the signal as originating from the sound source designated by the virtual sound source location angles 202.

### Example Virtual Rotation of Binaural Audio Signals

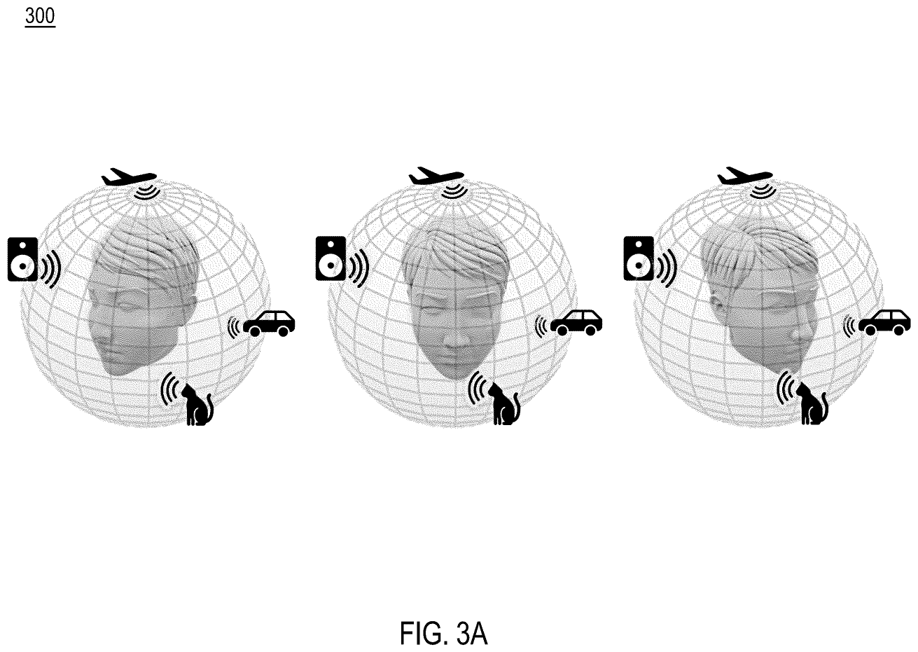

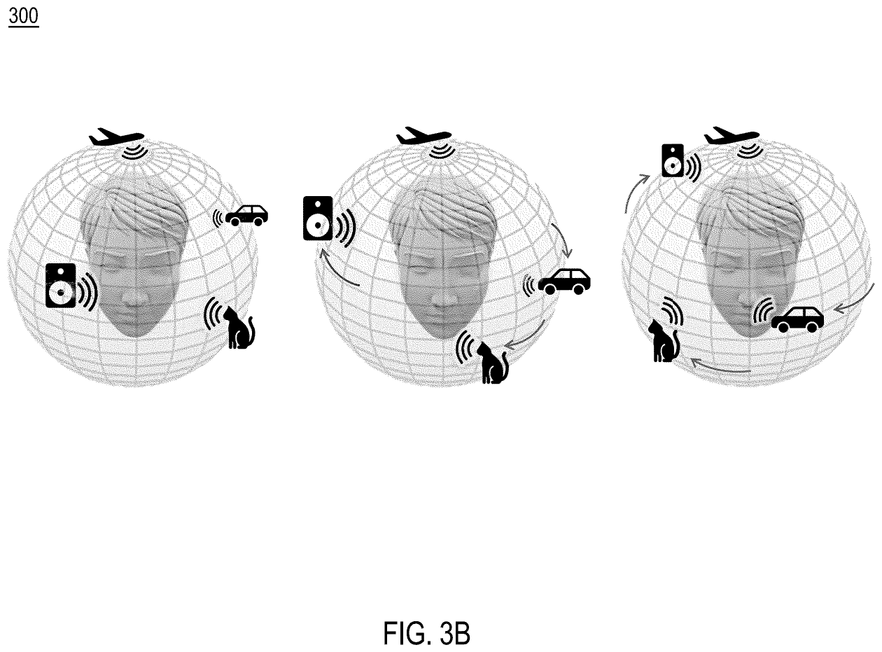

FIG. 3A illustrates four fixed sound sources around a person's head, in accordance with various embodiments. In particular, as shown in FIG. 3A, the sound sources (a phone, an airplane, a car, and a cat) remain fixed on the illustrative sphere, and when the person rotates their head, the location of the sources with respect to the person's ears changes. Thus, the person can perceive an approximate location in their environment for each fixed source. When a person rotates their head by a selected angle, the angular spherical location of each sound source changes with an equivalent angle in the opposite direction from the head rotation.

FIG. 3B illustrates rotation of the four fixed sound sources around a person's head, in accordance with various embodiments. In particular, FIG. 3B illustrates a virtual environment in which the person's head remains fixed and instead, the source locations move with respect to the head, causing the approximate location of the source location with respect to the head to change in the same way as if the head was rotated. Thus, a counterclockwise rotation of a person's head by a selected angle is equivalent to a clockwise rotation of each sound source around that person's head by the same selected angle. When a listener is wearing headphones (or earphones), and the position of the user's head with respect to the headphone speakers is fixed, the equivalency can be used to change the perceived sound source locations. In particular, using the equivalency (of counterclockwise rotation of a person's head to clockwise rotation of each sound source), when a user is wearing headphones that are playing binaural signals to generate a binaural sound environment, the perceived sound source locations can move with the person's head movement by rotating the perceived audio source locations in the binaural signal by an equal but opposite angle from the head movement, as shown in FIG. 3B.

### Example Virtual Rotation System Overview

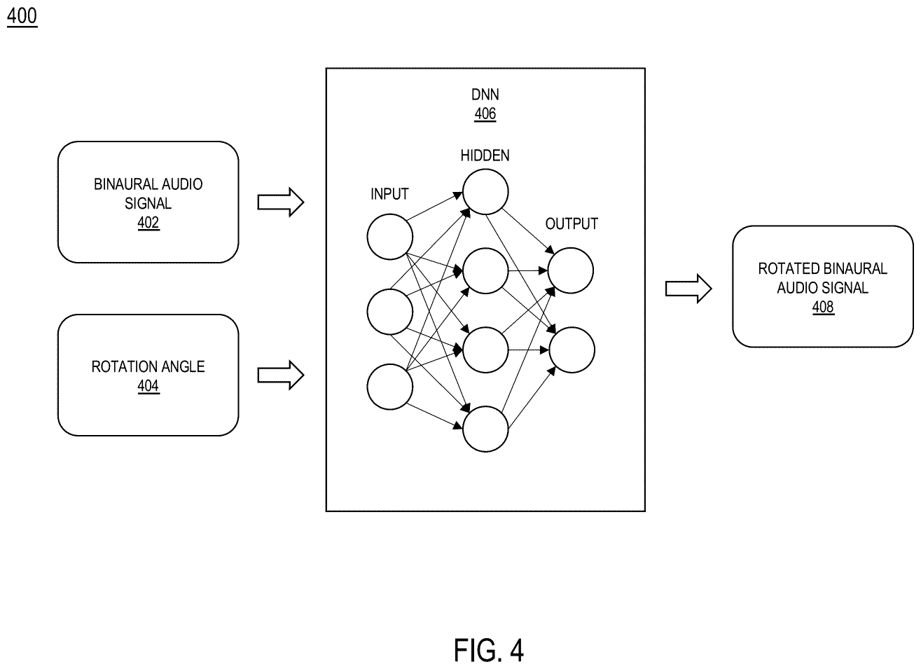

FIG. 4 is a diagram of an example virtual rotation system 400, in accordance with various embodiments. In particular, as shown in FIG. 4, the system 400 includes a neural network 406, which receives a binaural audio signal 402 and a rotation angle 404. The neural network 406 can be a regression neural network that uses the binaural audio signal 402 and the rotation angle 404 as input and generates a new binaural audio output signal 408 with the rotated environment indicated by the rotation angle 404. According to various implementations, the neural network 406 can be a deep neural network, as described in greater detail below.

### Example DNN System

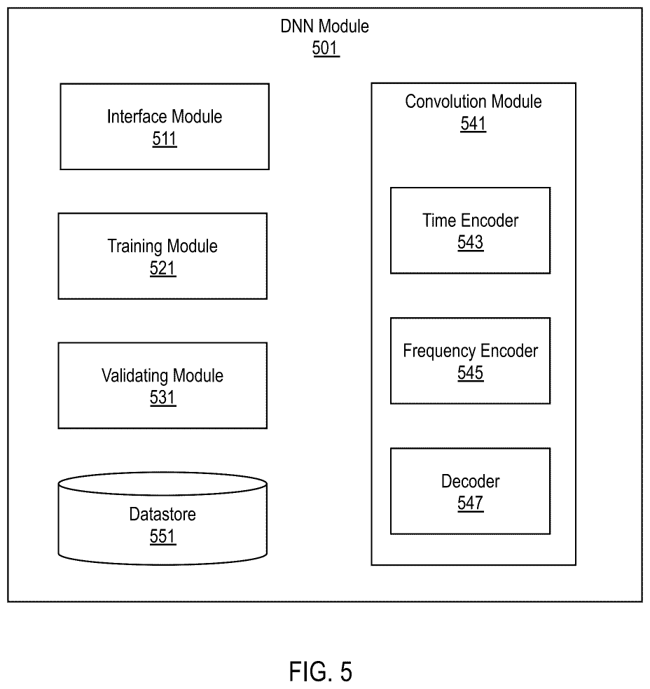

FIG. 5 is a block diagram of a deep neural network (DNN) module 501 that can be used for a virtual rotation system, in accordance with various embodiments. In the embodiments of FIG. 5, the DNN module 501 includes an interface module 511, a training module 521, a validating module 531, a convolution module 541, and a datastore 551. In other embodiments, alternative configurations, different or additional components may be included in the DNN module 501. Further, functionality attributed to a component of the DNN module 501 may be accomplished by a different component included in the DNN module 501 or a different module or system, such as any of the neural networks and/or deep learning systems described herein.

The interface module 511 facilitates communications of the DNN module 501 with other modules or systems. For example, the interface module 511 establishes communications between the DNN module 501 with an external database to receive data that can be used to train DNNs or input into DNNs to perform tasks. As another example, the interface module 511 supports the DNN module 501 to distribute DNNs to other systems, e.g., computing devices configured to apply DNNs to perform tasks.

The training module 521 trains DNNs by using a training dataset. In some examples, the training dataset can be generated using synthetic audio samples using HRTFs. Multiple datasets can be used to provide a variety of audio source types (e.g., human speech, instruments, animals, environmental sounds, etc.). For each sample in a dataset, a number of random audio sources can be selected and a random angle direction can be assigned to each selected audio source. Each of the selected audio sources can be rendered from a respective direction based on the assigned random angle using the corresponding HRTFs, and audio sources can be mixed to produce training input data. To generate the training output, a second random direction can be determined to represent the new head orientation, and, based on the new head orientation and the input direction of each of the audio sources, new relative audio source directions with respect to the head can be determined for each of the audio sources.

In an embodiment where the training module 521 trains a DNN to generate binaural signals with selected perceived source locations, the training dataset includes training binaural signals and training labels. The training labels describe ground-truth locations of sound sources in the training signals. In some embodiments, each label in the training dataset corresponds to an angle (with respect to a center line and plane) in a training stereo sound space. In some embodiments, each label in the training dataset corresponds to a location in a training stereo sound space. In some embodiments, a part of the training dataset may be used to initially train the DNN, and the rest of the training dataset may be held back as a validation subset used by the validating module 531 to validate performance of a trained DNN. The portion of the training dataset not including the tuning subset and the validation subset may be used to train the DNN.

The training module 521 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 3, 30, 300, 500, or even larger.

The training module 521 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input signal, such as frequency, volume, and other spectral characteristics. The output layer includes labels of angles and/or locations of sound sources in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input signals to perform feature extraction. In some examples, the feature extraction is based on a spectrogram of an input sound signal. A pooling layer is used to reduce the volume of input signal after convolution. It is used between two convolution layers. A fully connected layer involves weights, biases, and neurons. It connects neurons in one layer to neurons in another layer. It is used to classify signals between different categories by training. Note that training a DNN is different from using the DNN in real-time and when using a DNN to process data that is received in real-time, latency can become an issue that is not present during training, when the data set can be pre-loaded.

In the process of defining the architecture of the DNN, the training module 521 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 521 defines the architecture of the DNN, the training module 521 inputs a training dataset into the DNN. The training dataset includes a plurality of training samples. An example of a training sample includes source location of a feature in an audio sample and a ground-truth location of the feature. The training module 521 modifies the parameters inside the DNN (“internal parameters of the DNN”) to minimize the error between labels of the training features that are generated by the DNN and the ground-truth labels of the features. The internal parameters include weights of filters in the convolutional layers of the DNN. In some embodiments, the training module 521 uses a cost function to minimize the error.

The training module 521 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 521 finishes the predetermined number of epochs, the training module 521 may stop updating the parameters in the DNN. The DNN having the updated parameters is referred to as a trained DNN.

The validating module 531 verifies accuracy of trained or compressed DNNs. In some embodiments, the validating module 531 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validating module 531 may determine an accuracy score measuring the precision, recall, or a combination of precision and recall of the DNN. The validating module 531 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validating module 531 may compare the accuracy score with a threshold score. In an example where the validating module 531 determines that the accuracy score of the augmented model is less than the threshold score, the validating module 531 instructs the training module 521 to re-train the DNN. In one embodiment, the training module 521 may iteratively re-train the DNN until the occurrence of a stopping condition, such as the accuracy measurement indication that the DNN may be sufficiently accurate, or a number of training rounds having taken place.

The convolution module 541 performs real-time data processing, such as for speech enhancement, dynamic noise suppression, blind source separation, and/or self-noise silencing. In the embodiments of FIG. 5, the convolution module 541 includes time domain encoder 543, a frequency domain encoder 545, and a time domain decoder 547. In some examples, the time domain encoder 543 is a convolutional time domain encoder, the frequency domain encoder 545 is a convolutional frequency domain spectrum encoder, and the time domain decoder 547 is a convolutional time domain decoder. In various examples, the convolution module 541 also receives an input vector with x, y, and z components representing the head rotation direction, which is used to transform the binaural audio to match the rotation direction of the head. In other embodiments, alternative configurations, different or additional components may be included in the convolution module 541. Further, functionality attributed to a component of the convolution module 541 may be accomplished by a different component included in the convolution module 541, the DNN module 501, or a different module or system.

The encoder 545 receives short form Fourier transform (STFT) spectra. In various examples, the input data to the encoder 545 is frequency domain STFT spectra derived from input audio data. The input data includes input tensors which can each include multiple frames of data.

In various examples, a STFT is a Fourier-related transform used to determine the sinusoidal frequency and phase content of local sections of a signal as it changes over time. Generally, STFTs are computed by dividing a longer time signal into shorter segments of equal length and then computing the Fourier transform separately on each shorter segment. This results in the Fourier spectrum on each shorter segment. The changing spectra can be plotted as a function of time, for instance as a spectrogram. In some examples, the STFT is a discrete time STFT, such that the data to be transformed is broken up into tensors or frames (which usually overlap each other, to reduce artifacts at the boundary). Each tensor or frame is Fourier transformed, and the complex result is added to a matrix, which records magnitude and phase for each point in time and frequency. In some examples, an input tensor has a size of H×W×C, where H denotes the height of the input tensor (e.g., the number of rows in the input tensor or the number of data elements in a row), W denotes the width of the input tensor (e.g., the number of columns in the input tensor or the number of data elements in a row), and C denotes the depth of the input tensor (e.g., the number of input channels).

An inverse STFT can be generated by inverting the STFT. In various examples, the STFT is processed by the DNN, and it is then inverted at the decoder 547, or before being input to the decoder 547. By inverting the STFT, the encoded frequency domain signal from the frequency encoder 545 can be recombined with the encoded time domain signal from the time encoder 543. One way of inverting the STFT is by using the overlap-add method, which also allows for modifications to the STFT complex spectrum. This makes for a versatile signal processing method, referred to as the overlap and add with modifications method. In various examples, the output from the decoder 547 is a rotated binaural time domain audio output signal.

The datastore 551 stores data received, generated, used, or otherwise associated with the DNN module 501. For example, the datastore 551 stores the datasets used by the training module 521 and validating module 531. The datastore 551 may also store data generated by the training module 251 and validating module 531, such as the hyperparameters for training DNNs, internal parameters of trained DNNs (e.g., weights, etc.), data for sparsity acceleration (e.g., sparsity bitmap, etc.), and so on. In some embodiments the datastore 551 is a component of the DNN module 501. In other embodiments, the datastore 551 may be external to the DNN module 501 and communicate with the DNN module 501 through a network.

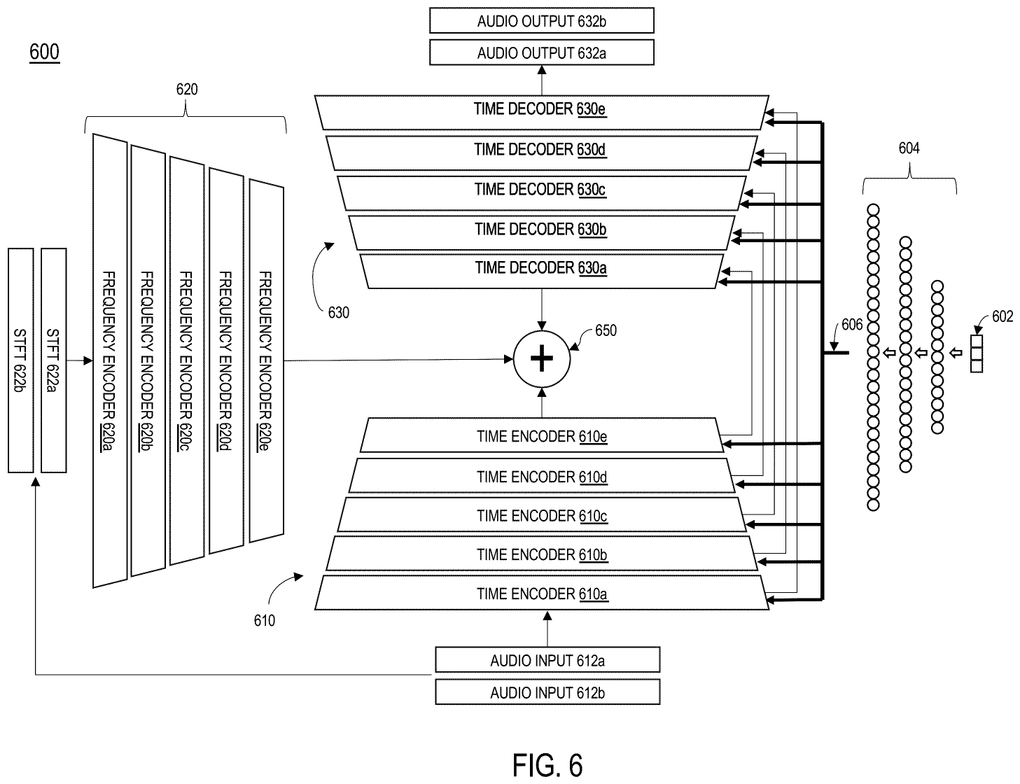

FIG. 6 is a block diagram illustrating an example of a neural network architecture 600 that can perform virtual rotation of input sound locations, in accordance with various embodiments. The neural network architecture includes time domain binaural input signals 612a, 612b, and frequency domain binaural input signals 622a, 622b. In some examples, the frequency domain input signals 622a, 622b are spectra transformed from the time domain input signals 612a, 612b. In some examples, a short-time Fourier transform is used to transform the time domain input signals 612a, 612b to frequency domain STFT spectra.

The time domain input signals 612a, 612b are input to a time domain encoder 610, which includes multiple time domain encoder layers 610a, 610b, 610c, 610d, 610e. In some examples, the time domain encoder 610 is a convolutional encoder and includes convolutional U-Nets for time domain signals. The time domain encoder 610 receives the two channels of time domain input signals 612a, 612b at a first time domain encoder convolutional layer 610a. The time domain encoder 610 also receives an input representing the spherical direction in which the head has rotated. The spherical direction in which the head has rotated can be input to the neural network architecture 600 as cartesian coordinates 602 (x, y, z components of a vector that represents the direction in which the head has rotated) or using another coordinate system. In various examples, the vector component input, including the cartesian coordinates 602, is processed by multiple fully connected neural network layers (vector component layers 604). In some examples, the vector component layers 604 expand the coordinates 602 into a vector and/or a tensor, using methods similar to the methods used by neural network encoders and/or neural network decoders. In some examples, expanding the input to the neural network can improve neural network training routines and/or training outcomes. The output 606 of the vector component layers 604 is input to each layer 610a, 610b, 610c, 610d, 610e of the time domain encoder 610. The neural network 600 uses the output 606 from the vector component layers 604 to transform the audio time domain input signals 612a, 612b to produce the binaural audio output 632a, 632b that matches the new perspective of the head.

The first time domain encoder convolutional layer 610a processes the two channels of time domain input signals 612a, 612b and the output of the vector component layers 604, and outputs 128 channels of time domain outputs to a second time domain encoder convolutional layer 610b. The second time domain encoder convolutional layer 610b receives the 128 channels of time domain signals and the output of the vector component layers 604, and outputs 256 channels of time domain outputs to a third time domain encoder convolutional layer 610c. The third time domain encoder convolutional layer 610c receives the 256 channels of time domain signals and the output of the vector component layers 604, and outputs 512 channels of time domain outputs to a fourth time domain encoder convolutional layer 610d. The fourth time domain encoder convolutional layer 610d receives the 512 channels of time domain signals and the output of the vector component layers 604, and outputs 1024 channels of time domain outputs to a fifth time domain encoder convolutional layer 610e. The fifth time domain encoder convolutional layer 610e receives the 1024 channels of time domain signals and the output of the vector component layers 604, and outputs 2048 channels of time domain outputs. In some examples, the output from fifth time domain encoder convolutional layer 610e is the output from the time domain encoder 610. The output from the time domain encoder 610 is input to an adder 650.

The frequency domain input signals 622a, 622b are input to a frequency domain encoder 620, which includes multiple frequency domain encoder layers 620a, 620b, 620c, 620d, 620e. In some examples, the frequency domain encoder 620 is a convolutional encoder for frequency domain STFT spectra. The frequency domain encoder 620 receives the two channels of spectra (frequency domain input signals 622a, 622b) at a first frequency domain encoder convolutional layer 620a and outputs 128 channels of frequency domain outputs to a second frequency domain encoder convolutional layer 620b. The second frequency domain encoder convolutional layer 620b receives the 128 channels of time domain signals and outputs 256 channels of frequency domain outputs to a third frequency domain encoder convolutional layer 620c. The third frequency domain encoder convolutional layer 620c receives the 256 channels of frequency domain signals and outputs 512 channels of frequency domain outputs to a fourth frequency domain encoder convolutional layer 620d. The fourth frequency domain encoder convolutional layer 620d receives the 512 channels of frequency domain signals and outputs 1024 channels of frequency domain outputs to a fifth frequency domain encoder convolutional layer 620e. The fifth frequency domain encoder convolutional layer 620e receives the 1024 channels of frequency domain signals and outputs 2048 channels of frequency domain outputs. In some examples, the output from fifth frequency domain encoder convolutional layer 620e is the output from the frequency domain encoder 620. The output from the frequency domain encoder 620 is input to the adder 650, where it is combined with the output from the time domain encoder 610.

The output from the adder 650 is received by a time domain decoder 630. The time domain decoder 630 includes multiple time domain decoder layers 630a, 630b, 630c, 630d, 630e. In some examples, the time domain decoder 630 is a convolutional decoder and includes convolutional U-Nets for time domain signals. The time domain decoder 630 also receives an input representing the spherical direction in which the head has rotated. In particular, the output 606 of the vector component layers 604 is input to each layer 630a, 630b, 630c, 630d, 630e of the time domain decoder 630. The neural network 600 uses the output 606 from the vector component layers 604 to produce the binaural audio output 632a, 632b that matches the new perspective of the head. The time domain decoder also receives output signals directly from corresponding layers of the time domain encoder. In particular, each layer 630a, 630b, 630c, 630d, 630e of the time domain decoder receives the output signal from the corresponding layer 610a, 610b, 610c, 610d, 610e that produced the same number of output channels and the decoder layer 630a, 630b, 630c, 630d, 630e receives as input.

The first time domain decoder convolutional layer 630a processes the 2048 channels of time domain input signals from the adder 650, 2048 channels of time encoder signals from the time encoder layer 610e, and the output 606 of the vector component layers 604, and outputs 1024 channels of time domain outputs to a second time domain decoder convolutional layer 630b. The second time domain decoder convolutional layer 630b receives the 1024 channels of time domain signals from the first time domain decoder convolutional layer 630a, 1024 channels of time encoder signals from the time encoder layer 610d, and the output 606 of the vector component layers 604, and outputs 512 channels of time domain outputs to a third time domain decoder convolutional layer 630c. The third time domain encoder convolutional layer 630c receives the 512 channels of time domain signals from the second time domain decoder convolutional layer 630b, 512 channels of time encoder signals from the time encoder layer 610c, and the output 606 of the vector component layers 604, and outputs 256 channels of time domain outputs to a fourth time domain decoder convolutional layer 630d. The fourth time domain decoder convolutional layer 630d receives the 256 channels of time domain signals from the third time domain decoder convolutional layer 630c, 256 channels of time encoder signals from the second time encoder layer 610b, and the output 606 of the vector component layers 604, and outputs 128 channels of time domain outputs to a fifth time domain decoder convolutional layer 630e. The fifth time domain decoder convolutional layer 630e receives the 128 channels of time domain signals from the fourth time domain decoder convolutional layer 630d, 128 channels of time domain signals from the first time domain encoder convolutional layer 610a, and the output 606 of the vector component layers 604, and outputs two channels of time domain outputs 632a, 632b. In some examples, the output from fifth time domain decoder convolutional layer 630e is the output from the time domain decoder 630, and the output from the decoder 630 is the output from the neural network architecture 600.

In some examples, the time domain encoder 610 and the frequency domain encoder 620 can have a shared cross-domain bottleneck, such that both the time domain encoder 610 output and the frequency domain encoder 620 output are added into additional encoder layers before reaching the decoder 630.

The neural network architecture 600 including the time domain encoder 610 and the time domain decoder 630, with multiple blocks and block-wise skip connections, can be a U-Net. The addition of the frequency domain encoder 620 results in the additional frequency domain encoder 620 output, which is combined with the time domain encoder 610 output on the U-Net bottleneck at the adder 650. Thus, the neural network architecture 600 is a multi-domain architecture.

According to various implementations, the neural network architecture 600 shown in FIG. 6 is one example of a neural network that can be utilized for virtual rotation of signal source locations. In various examples, the neural network can have an architecture similar to demucs, and/or a hybrid demucs. In some examples, the architecture can include a U-Net encoder and/or decoder structure. In some examples, the encoder and decoder can have symmetric structures. In some examples, an encoder layer includes a convolution. In one example, the convolution can have a kernel size of eight, a stride of four, a first layer with a fixed number of channels (e.g., 48 or 64), and a doubling of the number of channels in subsequent layers. The neural network architecture can include a rectified linear unit (ReLU), and the neural network architecture can include a 1×1 convolution with a Gated Linear Unit Activation. A decoder layer can sum the contribution from the U-Net skip connection and the previous layer, apply a 1×1 convolution with GLU. In some examples, the audio input data is 44.1 kHz audio. In some examples, the input audio data is upsampled by a factor of two before it is input to the encoder (in order to limit aliasing from the outermost layers), and the output from the decoder is downsampled by a factor of two.

In some examples, the neural network is a hybrid demucs inspired architecture and includes multi-domain analysis and prediction capabilities. The architecture can include a temporal branch, a spectral branch, and shared layers. The temporal branch receives as input a waveform and processes the waveform. In some examples, the temporal branch includes Gaussian Error Linear Units (GELU) for activations. In some examples, the temporal branch includes multiple layers (e.g., five layers) and the layers reduce the number of time steps by a factor of 1024. The spectral branch receives as input a spectrogram generated using a STFT function. The spectrogram is a frequency representation of the waveform input to the temporal branch. In some examples, the STFT is obtained over 4096 time steps with a hop length of 1024. Thus, in some examples, the number of time steps for the spectral branch matches that of the output of the temporal branch encoder. In some examples, the spectral branch performs the same convolutions as the temporal branch, but the spectral branch performs the convolutions in the frequency dimension. Each layer of the spectral branch reduces the number of frequencies by a factor of four. In some examples, a fifth layer of the spectral branch reduces the number of frequencies by a factor of eight.

In some examples, the spectral branch can perform frequency-wise convolutions. The number of frequency bins can be divided by four at each layer of the neural network. In some examples, the last layer has eight frequency bins, which can be reduced to one with a convolution with a kernel size of eight and no padding. In some examples, the spectrogram input to the neural network can be represented as an amplitude spectrogram, or as complex numbers. In some examples, the spectral branch output is transformed to a waveform, and summed with the temporal branch output, and the output from the summer is in the waveform domain.

### Example Method for Virtual Rotation

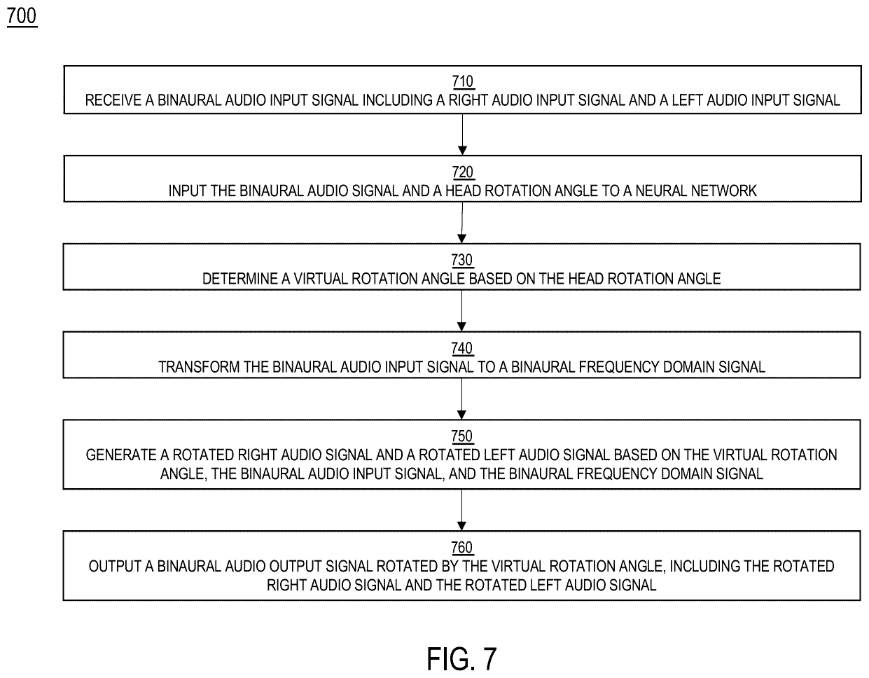

FIG. 7 is a flow chart of an example method 700 for virtual rotation of binaural audio signals, in accordance with various embodiments. At step 710, a binaural audio input signal is received including a right audio input signal and a left audio input signal. At step 720, the binaural audio signal and a head rotation angle are input to a neural network. In various examples, the neural network is configured to output a virtual rotation of the binaural audio input signal, where the virtual rotation includes processing the binaural audio input signal to change the perceived source location of sounds in the binaural audio input signal such that the sound locations are perceived to be unchanged despite the head rotating. Thus, in various examples, the sound locations are not perceived to rotate with the head even when a listener is wearing headphones.

At step 730, a virtual rotation angle is determined based on the head rotation angle. As described above, the virtual rotation angle can be the opposite of the head rotation angle. At step 740, the binaural audio input signal is transformed to a binaural frequency domain signal. In some examples, a Fourier Transform is used to transform the signal, and in some examples, a STFT is used to transform the signal to a binaural frequency domain signal.

At step 750, a rotated right audio signal and a rotated left audio signal are generated based on the virtual rotation angle, the binaural audio input signal, and the binaural frequency domain signal. As described above, a neural network such as the DNN module 501 of FIG. 5 or the neural network 600 of FIG. 6 can generate virtually rotated right and left audio signals based on the virtual rotation angle and the binaural audio input signal. According to various examples, the virtually rotated right and left audio signals are adjusted to alter the perceived source location of various sounds in the right and left audio input signals such that the perceived source location of various sounds is virtually rotated by the virtual rotation angle. At step 760, a binaural audio output signal that is rotated by the virtual rotation angle is output from the neural network. The binaural audio output signal includes the rotated right audio signal and the rotated left audio signal.

### Example Computing Device

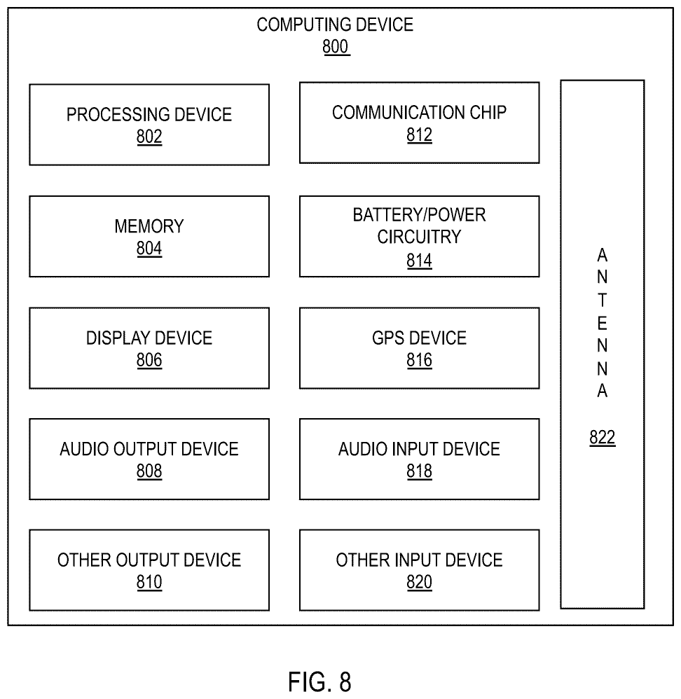

FIG. 8 is a block diagram of an example computing device 800, in accordance with various embodiments. In some embodiments, the computing device 800 may be used for at least part of the DNN module 501 in FIG. 5, and the neural network 600 of FIG. 6. A number of components are illustrated in FIG. 8 as included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, but the computing device 800 may include interface circuitry for coupling to the one or more components. For example, the computing device 800 may not include a display device 806, but may include display device interface circuitry (e.g., a connector and driver circuitry) to which a display device 806 may be coupled. In another set of examples, the computing device 800 may not include a video input device 818 or a video output device 808, but may include video input or output device interface circuitry (e.g., connectors and supporting circuitry) to which a video input device 818 or video output device 808 may be coupled.

The computing device 800 may include a processing device 802 (e.g., one or more processing devices). The processing device 802 processes electronic data from registers and/or memory to transform that electronic data into other electronic data that may be stored in registers and/or memory. The computing device 800 may include a memory 804, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 804 may include memory that shares a die with the processing device 802. In some embodiments, the memory 804 includes one or more non-transitory computer-readable media storing instructions executable for occupancy mapping, e.g., the method 700 described above in conjunction with FIG. 7 or some operations performed by the DNN system 501 in FIG. 5 or operations performed by the CNN system 600 of FIG. 6. The instructions stored in the one or more non-transitory computer-readable media may be executed by the processing device 802.

In some embodiments, the computing device 800 may include a communication chip 812 (e.g., one or more communication chips). For example, the communication chip 812 may be configured for managing wireless communications for the transfer of data to and from the computing device 800. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 812 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 812 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 812 may operate in accordance with other wireless protocols in other embodiments. The computing device 800 may include an antenna 822 to facilitate wireless communications and/or to receive other wireless communications (such as AM or FM radio transmissions).

In some embodiments, the communication chip 812 may manage wired communications, such as electrical, optical, or any other suitable communication protocols (e.g., the Ethernet). As noted above, the communication chip 812 may include multiple communication chips. For instance, a first communication chip 812 may be dedicated to shorter-range wireless communications such as Wi-Fi or Bluetooth, and a second communication chip 812 may be dedicated to longer-range wireless communications such as global positioning system (GPS), EDGE, GPRS, CDMA, WiMAX, LTE, EV-DO, or others. In some embodiments, a first communication chip 812 may be dedicated to wireless communications, and a second communication chip 812 may be dedicated to wired communications.

The computing device 800 may include battery/power circuitry 814. The battery/power circuitry 814 may include one or more energy storage devices (e.g., batteries or capacitors) and/or circuitry for coupling components of the computing device 800 to an energy source separate from the computing device 800 (e.g., AC line power).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include a video output device 808 (or corresponding interface circuitry, as discussed above). The video output device 808 may include any device that generates an audible indicator, such as speakers, headsets, or earbuds, for example.

The computing device 800 may include a video input device 818 (or corresponding interface circuitry, as discussed above). The video input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include another output device 810 (or corresponding interface circuitry, as discussed above). Examples of the other output device 810 may include a video codec, a video codec, a printer, a wired or wireless transmitter for providing information to other devices, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader. The computing device 800 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 800 may be any other electronic device that processes data.

### SELECTED EXAMPLES

The following paragraphs provide various examples of the embodiments disclosed herein.

Example 1 provides a computer-implemented method, including receiving a binaural audio input signal including a right audio input signal and a left audio input signal; inputting, to a neural network, the binaural audio signal and a head rotation angle; determining, at the neural network, a virtual rotation angle based on the head rotation angle; transforming, at the neural network, the binaural audio input signal to a binaural frequency domain signal; generating, by the neural network, a rotated right audio signal and a rotated left audio signal, based on the virtual rotation angle, the binaural audio input signal, and the binaural frequency domain signal; outputting, by the neural network, a binaural audio output signal rotated by the virtual angle, including the rotated right audio signal and the rotated left audio signal.

Example 2 provides the computer-implemented method of example 1, where the neural network includes a time domain encoder including a plurality of time domain encoder layers, and further including inputting the right audio input signal, the left audio input signal, and the virtual rotation angle to a first time domain encoder layer of the plurality of time domain encoder layers, and outputting a plurality of time domain encoded signals from the time domain encoder.

Example 3 provides the computer-implemented method of example 2, where a second time domain encoder layer of the plurality of time domain encoder layers receives an output from the first time domain encoder layer and the virtual rotation angle.

Example 4 provides the computer-implemented method of example 3, where a number of channels output from each of the plurality of time domain encoder layers is greater than a number of channels input to each of the plurality of time domain encoder layers.

Example 5 provides the computer-implemented method of example 2, where the neural network includes a frequency domain encoder including a plurality of frequency domain encoder layers, and further including inputting the binaural frequency domain signal to a first frequency domain encoder layer of the plurality of frequency domain encoder layers, and outputting a plurality of frequency domain encoded signals from the frequency domain encoder.

Example 6 provides the computer-implemented method of example 5, where the neural network includes an adder, and further including adding the plurality of time domain encoded signals and the plurality of frequency domain encoded signals to generate a plurality of added encoded signals, and inputting the plurality of added encoded signals to a time domain decoder.

Example 7 provides the computer-implemented method of example 1, where the head rotation angle includes cartesian coordinates representing a direction in which a head rotated.

Example 8 provides the computer-implemented method of example 1, further including training the neural network using synthetic audio samples generated using head rotation transfer functions.

Example 9 provides one or more non-transitory computer-readable media storing instructions executable to perform operations, the operations including receiving a binaural audio input signal including a right audio input signal and a left audio input signal; inputting, to a neural network, the binaural audio signal and a head rotation angle; determining, at the neural network, a virtual rotation angle based on the head rotation angle; transforming, at the neural network, the binaural audio input signal to a binaural frequency domain signal; generating, by the neural network, a rotated right audio signal and a rotated left audio signal, based on the virtual rotation angle, the binaural audio input signal, and the binaural frequency domain signal; outputting, by the neural network, a binaural audio output signal rotated by the virtual angle, including the rotated right audio signal and the rotated left audio signal.

Example 10 provides the one or more non-transitory computer-readable media of example 9, where the neural network includes a time domain encoder including a plurality of time domain encoder layers, and the operations further including inputting the right audio input signal, the left audio input signal, and the virtual rotation angle to a first time domain encoder layer of the plurality of time domain encoder layers, and outputting a plurality of time domain encoded signals from the time domain encoder.

Example 11 provides the one or more non-transitory computer-readable media of example 10, where the neural network includes a frequency domain encoder including a plurality of frequency domain encoder layers, and the operations further including inputting the binaural frequency domain signal to a first frequency domain encoder layer of the plurality of frequency domain encoder layers; and outputting a plurality of frequency domain encoded signals from the frequency domain encoder.

Example 12 provides the one or more non-transitory computer-readable media of example 11, where the neural network includes an adder, and the operations further including adding the plurality of time domain encoded signals and the plurality of frequency domain encoded signals to generate a plurality of added encoded signals; and inputting the plurality of added encoded signals to a time domain decoder.

Example 13 provides the one or more non-transitory computer-readable media of example 9, where the head rotation angle includes cartesian coordinates representing a direction in which a head rotated.

Example 14 provides the one or more non-transitory computer-readable media of example 9, the operations further including training the neural network using synthetic audio samples generated using head rotation transfer functions.

Example 15 provides an apparatus, including a computer processor for executing computer program instructions; and a non-transitory computer-readable memory storing computer program instructions executable by the computer processor to perform operations including receiving a binaural audio input signal including a right audio input signal and a left audio input signal; inputting, to a neural network, the binaural audio signal and a head rotation angle; determining, at the neural network, a virtual rotation angle based on the head rotation angle; transforming, at the neural network, the binaural audio input signal to a binaural frequency domain signal; generating, by the neural network, a rotated right audio signal and a rotated left audio signal, based on the virtual rotation angle, the binaural audio input signal, and the binaural frequency domain signal; outputting, by the neural network, a binaural audio output signal rotated by the virtual angle, including the rotated right audio signal and the rotated left audio signal.

Example 16 provides the apparatus of example 15, where the neural network includes a time domain encoder including a plurality of time domain encoder layers, and the operations further including inputting the right audio input signal, the left audio input signal, and the virtual rotation angle to a first time domain encoder layer of the plurality of time domain encoder layers, and outputting a plurality of time domain encoded signals from the time domain encoder.

Example 17 provides the apparatus of example 16, where the neural network includes a frequency domain encoder including a plurality of frequency domain encoder layers, and the operations further including inputting the binaural frequency domain signal to a first frequency domain encoder layer of the plurality of frequency domain encoder layers; and outputting a plurality of frequency domain encoded signals from the frequency domain encoder.

Example 18 provides the apparatus of example 17, where the neural network includes an adder, and the operations further including adding the plurality of time domain encoded signals and the plurality of frequency domain encoded signals to generate a plurality of added encoded signals; and inputting the plurality of added encoded signals to a time domain decoder.

Example 19 provides the apparatus of example 15, where the head rotation angle includes cartesian coordinates representing a direction in which a head rotated.

Example 20 provides the apparatus of example 15, the operations further including training the neural network using synthetic audio samples generated using head rotation transfer functions.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method, comprising:
receiving a binaural audio input signal including a right audio input signal and a left audio input signal;
inputting, to a neural network, the binaural audio input signal and a head rotation angle;
determining, at the neural network, a virtual rotation angle based on the head rotation angle;
transforming, at the neural network, the binaural audio input signal to a binaural frequency domain signal;
generating, by the neural network, a rotated right audio signal and a rotated left audio signal, based on the virtual rotation angle, the binaural audio input signal, and the binaural frequency domain signal; and
outputting, by the neural network, a binaural audio output signal rotated by the virtual rotation angle, including the rotated right audio signal and the rotated left audio signal.

2. The computer-implemented method of claim 1, wherein the neural network includes a time domain encoder including a plurality of time domain encoder layers, and further comprising:
inputting the right audio input signal, the left audio input signal, and the virtual rotation angle to a first time domain encoder layer of the plurality of time domain encoder layers; and
outputting a plurality of time domain encoded signals from the time domain encoder.

3. The computer-implemented method of claim 2, wherein a second time domain encoder layer of the plurality of time domain encoder layers receives an output from the first time domain encoder layer and the virtual rotation angle.

4. The computer-implemented method of claim 3, wherein a number of channels output from each of the plurality of time domain encoder layers is greater than a number of channels input to each of the plurality of time domain encoder layers.

5. The computer-implemented method of claim 2, wherein the neural network includes a frequency domain encoder including a plurality of frequency domain encoder layers, and further comprising:
inputting the binaural frequency domain signal to a first frequency domain encoder layer of the plurality of frequency domain encoder layers; and
outputting a plurality of frequency domain encoded signals from the frequency domain encoder.

6. The computer-implemented method of claim 5, wherein the neural network includes an adder, and further comprising adding the plurality of time domain encoded signals and the plurality of frequency domain encoded signals to generate a plurality of added encoded signals, and inputting the plurality of added encoded signals to a time domain decoder.

7. The computer-implemented method of claim 1, wherein the head rotation angle includes cartesian coordinates representing a direction in which a head rotated.

8. The computer-implemented method of claim 1, further comprising training the neural network using synthetic audio samples generated using head rotation transfer functions.

9. One or more non-transitory computer-readable media storing instructions executable to perform operations, the operations comprising:
receiving a binaural audio input signal including a right audio input signal and a left audio input signal;
inputting, to a neural network, the binaural audio input signal and a head rotation angle;
determining, at the neural network, a virtual rotation angle based on the head rotation angle;
transforming, at the neural network, the binaural audio input signal to a binaural frequency domain signal;
generating, by the neural network, a rotated right audio signal and a rotated left audio signal, based on the virtual rotation angle, the binaural audio input signal, and the binaural frequency domain signal; and
outputting, by the neural network, a binaural audio output signal rotated by the virtual rotation angle, including the rotated right audio signal and the rotated left audio signal.

10. The one or more non-transitory computer-readable media of claim 9, wherein the neural network includes a time domain encoder including a plurality of time domain encoder layers, and the operations further comprising:
inputting the right audio input signal, the left audio input signal, and the virtual rotation angle to a first time domain encoder layer of the plurality of time domain encoder layers; and
outputting a plurality of time domain encoded signals from the time domain encoder.

11. The one or more non-transitory computer-readable media of claim 10, wherein the neural network includes a frequency domain encoder including a plurality of frequency domain encoder layers, and the operations further comprising:
inputting the binaural frequency domain signal to a first frequency domain encoder layer of the plurality of frequency domain encoder layers; and
outputting a plurality of frequency domain encoded signals from the frequency domain encoder.

12. The one or more non-transitory computer-readable media of claim 11, wherein the neural network includes an adder, and the operations further comprising:
adding the plurality of time domain encoded signals and the plurality of frequency domain encoded signals to generate a plurality of added encoded signals; and
inputting the plurality of added encoded signals to a time domain decoder.

13. The one or more non-transitory computer-readable media of claim 9, wherein the head rotation angle includes cartesian coordinates representing a direction in which a head rotated.

14. The one or more non-transitory computer-readable media of claim 9, the operations further comprising training the neural network using synthetic audio samples generated using head rotation transfer functions.

15. An apparatus, comprising:
a computer processor for executing computer program instructions; and
a non-transitory computer-readable memory storing computer program instructions executable by the computer processor to perform operations comprising:
receiving a binaural audio input signal including a right audio input signal and a left audio input signal;
inputting, to a neural network, the binaural audio input signal and a head rotation angle;
determining, at the neural network, a virtual rotation angle based on the head rotation angle;
transforming, at the neural network, the binaural audio input signal to a binaural frequency domain signal;
generating, by the neural network, a rotated right audio signal and a rotated left audio signal, based on the virtual rotation angle, the binaural audio input signal, and the binaural frequency domain signal; and
outputting, by the neural network, a binaural audio output signal rotated by the virtual rotation angle, including the rotated right audio signal and the rotated left audio signal.

16. The apparatus of claim 15, wherein the neural network includes a time domain encoder including a plurality of time domain encoder layers, and the operations further comprising:
inputting the right audio input signal, the left audio input signal, and the virtual rotation angle to a first time domain encoder layer of the plurality of time domain encoder layers, and
outputting a plurality of time domain encoded signals from the time domain encoder.

17. The apparatus of claim 16, wherein the neural network includes a frequency domain encoder including a plurality of frequency domain encoder layers, and the operations further comprising:
inputting the binaural frequency domain signal to a first frequency domain encoder layer of the plurality of frequency domain encoder layers; and
outputting a plurality of frequency domain encoded signals from the frequency domain encoder.

18. The apparatus of claim 17, wherein the neural network includes an adder, and the operations further comprising:
adding the plurality of time domain encoded signals and the plurality of frequency domain encoded signals to generate a plurality of added encoded signals;
and inputting the plurality of added encoded signals to a time domain decoder.

19. The apparatus of claim 15, wherein the head rotation angle includes cartesian coordinates representing a direction in which a head rotated.

20. The apparatus of claim 15, the operations further comprising training the neural network using synthetic audio samples generated using head rotation transfer functions.
